(19) United States
(12) Patent Application Publication
(10) Pub. No.: US 2013/0046471 A1
(43) Pub. Date: Feb. 21, 2013

(54) SYSTEMS AND METHODS FOR DETECTING CRACKS IN TERRAIN SURFACES USING MOBILE LIDAR DATA

(71) Applicants: Mark Rahmes, Melbourne, FL (US); J. H. Yates, Melbourne, FL (US); Michael McGonagle, Melbourne, FL (US); George Lemieux, Indian Harbour Beach, FL (US)

(72) Inventors: Mark Rahmes, Melbourne, FL (US); J. H. Yates, Melbourne, FL (US); Michael McGonagle, Melbourne, FL (US); George Lemieux, Indian Harbour Beach, FL (US)

(73) Assignee: HARRIS CORPORATION, Melbourne, FL (US)

(21) Appl. No.: 13/212,253

(22) Filed: Aug. 18, 2011

(51) Int. Cl. G06F 19/00

(52) U.S. Cl. 702/5

(57) ABSTRACT

Systems (100) and methods (300) for automatically generating a quality metric for a specified surface area of a terrain (104). The methods involve acquiring mobile LIDAR data defining a geometry of the specified surface area of the terrain. The mobile LIDAR data is acquired by LIDAR equipment (106) disposed on a vehicle (102) traveling along the terrain. The methods also involve automatically determining a quality metric defining a quality of the specified surface area of the terrain using the mobile LIDAR data.

### BACKGROUND OF THE INVENTION

1. Statement of the Technical Field

The invention concerns computing systems. More particularly, the invention concerns computing systems and methods for detecting cracks in surfaces of roads, streets, bridges, sidewalks and other terrain using mobile Light Detection And Ranging (“LIDAR”) data.

2. Description of the Related Art

Preventive maintenance and rehabilitation for deteriorated roads are crucial for our transportation system. Each year, nearly twenty billion dollars are spent to maintain, repair, rehabilitate and reconstruct roads, streets, bridges and sidewalks in the United States. A percentage of the twenty billion dollars is spent to detect areas of roads, streets, bridges and sidewalks that need maintenance and rehabilitation. Such areas are typically detected manually or semi-manually by employees of the Department Of Transportation (“DOT”). For example, in manual scenarios, employees of the DOT visually and physically inspect the surfaces of roads, streets and sidewalks to identify cracks therein. In the semi-manual scenarios, employees of the DOT use LIDAR tripod equipment for detecting said cracks. After the cracks have been identified, the employees make notations and/or sketches in notebooks. The contents of the notebooks are then analyzed by the DOT to determine relative priorities of the areas having identified cracks. The priorities are then used to create a maintenance plan in which areas having relatively high priorities are repaired prior to the areas having relatively low priorities.

One can appreciate that the above described manual crack detection and maintenance plan creation process is inefficient, unsafe, time consuming and costly. Such a manual crack detection and maintenance plan creation process also provides inconveniences to members of the public traveling on the roads, streets, bridges and sidewalks. As such, there is a desire to devise alternative solutions for manual crack detection that reduce the inefficiencies, injuries, time, cost and inconveniences associated therewith. There is also a desire to devise alternative solutions for maintenance plan creation that reduce the inefficiencies, time and cost associated therewith.

### SUMMARY OF THE INVENTION

Embodiments of the invention concern implementing systems and methods for automatically generating a quality metric for a specified surface area of a terrain. The methods involve acquiring mobile LIDAR data defining a geometry of the specified surface area of the terrain. The mobile LIDAR data is acquired by LIDAR equipment disposed on a vehicle traveling along the terrain. The terrain includes, but is not limited to, a road, street, driveway, bridge, sidewalk or other terrain. The methods also involve automatically determining a quality metric defining a quality of the specified surface area of the terrain using the mobile LIDAR data. The quality metric can be subsequently used to determine a maintenance plan for the terrain.

### BRIEF DESCRIPTION OF THE DRAWINGS

Embodiments will be described with reference to the following drawing figures, in which like numerals represent like items throughout the figures, and in which:

FIG. 1 is a schematic illustration of an exemplary system that is useful for understanding the present invention.

FIG. 2 is a block diagram of an exemplary computing device that is useful for understanding the present invention.

FIGS. 3A-3C collectively provide a flow diagram of an exemplary method for crack detection and maintenance plan creation that is useful for understanding the present invention.

FIG. 4 is a schematic illustration of pixels defining a crack and a pore that is useful for understanding the present invention.

FIG. 5 is a schematic illustration of pixels defining a crack having a spur that is useful for understanding the preset invention.

FIGS. 6A-6B provide schematic illustrations of cracks that are useful for understanding a crack connecting process of the present invention.

FIGS. 7A-7B provide schematic illustrations of cracks that are useful for understanding a crack thinning process of the present invention.

FIGS. 8A-8B provide schematic illustrations of cracks that are useful for understanding a crack smoothing process that is useful for understanding the present invention.

FIG. 9 is a flow diagram of an exemplary binarization process that is useful for understanding the present invention.

FIGS. 10A-10C collectively provide a flow diagram of an exemplary quality metric determination process that is useful for understanding the present invention.

FIG. 11 is a flow diagram of an exemplary data compression process that is useful for understanding the present invention.

FIG. 12 is a schematic illustration of non-compressed and compressed cracks that is useful for understanding an exemplary data compression process of the present invention.

### DETAILED DESCRIPTION

The present invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

The present invention concerns implementing systems and methods for automatically detecting cracks in surfaces of roads, streets, bridges, driveways, sidewalks and other terrain using mobile LIDAR data, and for automatically generating quality metrics useful for creating a maintenance plan for roads, streets, bridges, driveways, sidewalks or other terrain. Notably, the present invention overcomes various drawbacks of conventional terrain maintenance techniques, such as those described above in the background section of this document. For example, the present invention provides a solution for manual crack detection that reduces the inefficiencies, injuries, time, cost and inconveniences associated with conventional manual crack detection techniques. The present invention also provides a solution for maintenance plan creation that reduces the inefficiencies, time and cost associated with conventional maintenance plan creation techniques.

Method embodiments generally involve acquiring mobile LIDAR data defining a geometry of the specified surface area of the terrain. The mobile LIDAR data is acquired by LIDAR equipment disposed on a vehicle traveling along the terrain. The terrain includes, but is not limited to, a road, street, driveway, bridge, sidewalk or other terrain. The methods also involve automatically determining a quality metric defining a quality of the specified surface area of the terrain using the mobile LIDAR data. The quality metric can be subsequently used to determine a maintenance plan for the terrain.

According to aspects of the present invention, the quality metric is determined by performing one or more of a binarization process, a pore filling process, a spur removal process, a crack connection process, a crack thinning process, a crack smoothing process, a minutiae extraction process, and a quality metric generation process. The binarization process generally involves using the mobile LIDAR data to obtain Black-And-White (“BAW”) LIDAR data. The BAW LIDAR data comprises black pixels and white pixels, wherein the black pixels define the cracks. The BAW LIDAR data is obtained by determining propagation directions of the cracks, aligning a steerable filter to the propagation directions, and using the steerable filter to convert the mobile LIDAR data to the BAW LIDAR data. Thereafter, the BAW LIDAR data is processed to obtain various information for subsequent use in determining the quality metric. The various information includes, but is not limited to, an average width of cracks defined by the BAW LIDAR data, a total number of pores defined by the BAW LIDAR data, and a total number of spurs defined by the BAW LIDAR data.

The crack thinning process generally involves processing the BAW LIDAR data to obtain first modified BAW LIDAR data defining cracks having widths of one pixel. As such, in certain embodiments, black pixels of the first modified BAW LIDAR data will have one (1), two (2) or three (3) neighboring black pixels. However, the present invention is not limited in this regard. For example, bifurcation black pixels can have more than three neighboring black pixels. The crack smoothing process generally involves processing the first modified BAW LIDAR data to reduce a pixel-wide noise thereof so as to obtain second modified BAW LIDAR data with smoothed cracks. The minutiae extraction process generally involves identifying black pixels of the second modified BAW LIDAR data defining cracks that constitute minutiae and determining locations of the minutiae.

The quality metric generation process generally involves comparing a threshold value to a quality measure. The quality measure includes, but is not limited to, a total number of cracks defined by data, a total number of pores defined by the data, a total number of spurs defined by the data, a total number of crack connections made, a total number of spurs removed, an average length of the cracks, an average width of the cracks, a total number of minutiae, a density of the minutiae, a depth of the cracks, or a ridge flow disturbance.

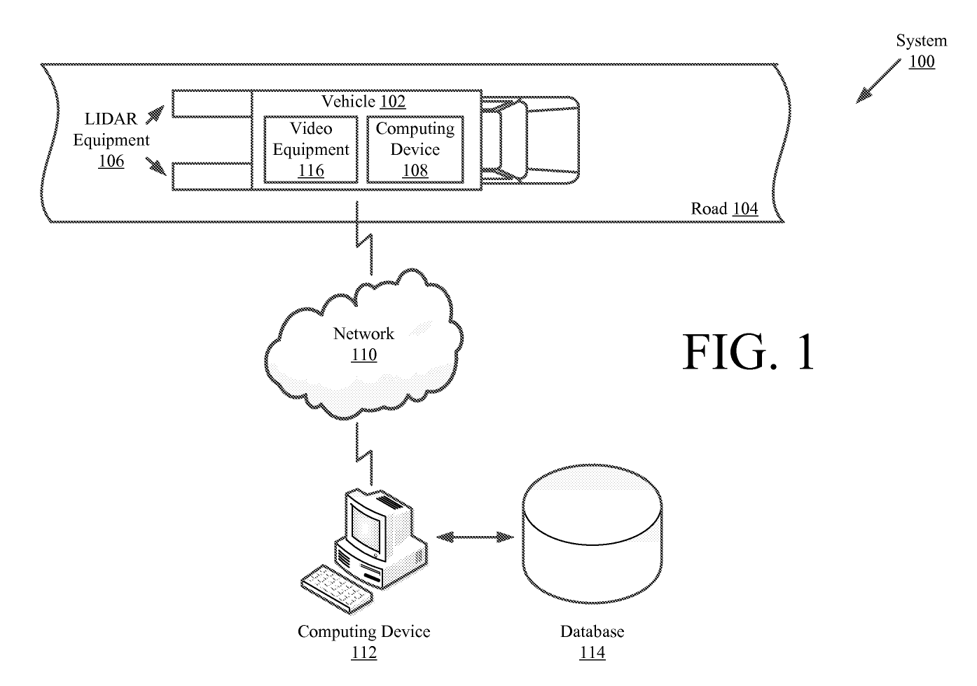

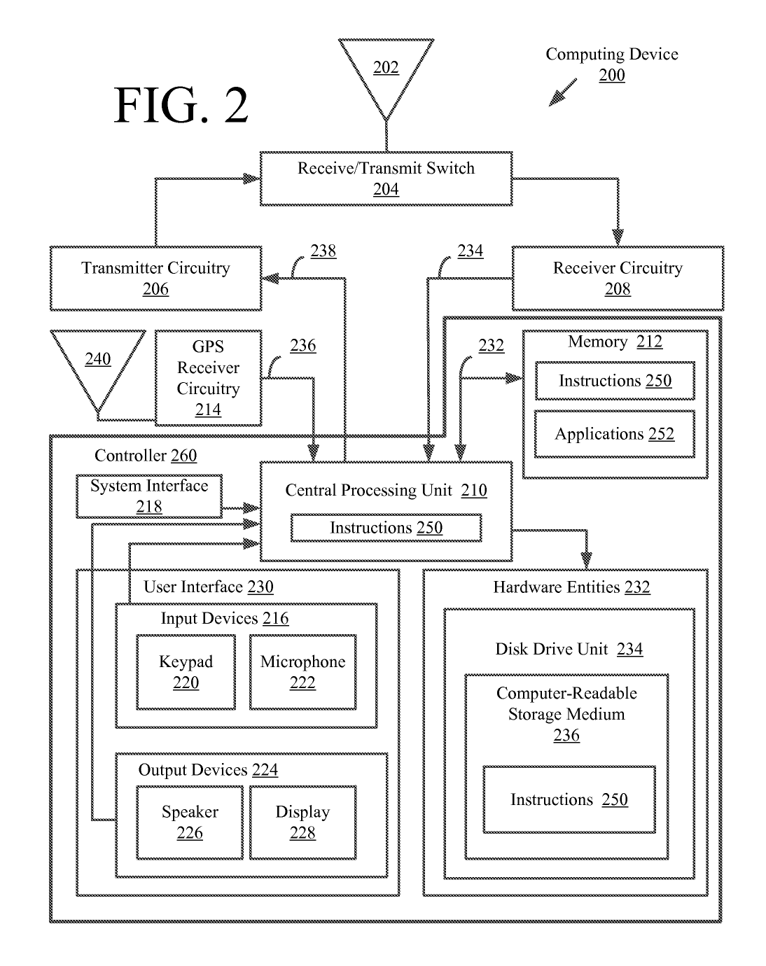

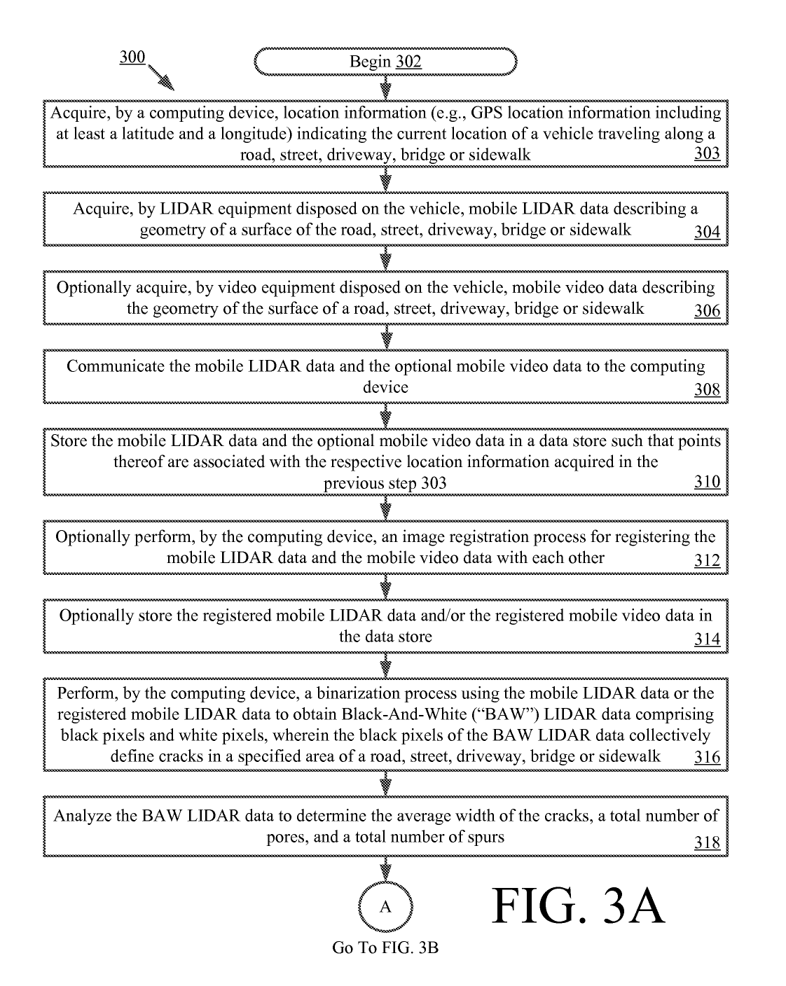

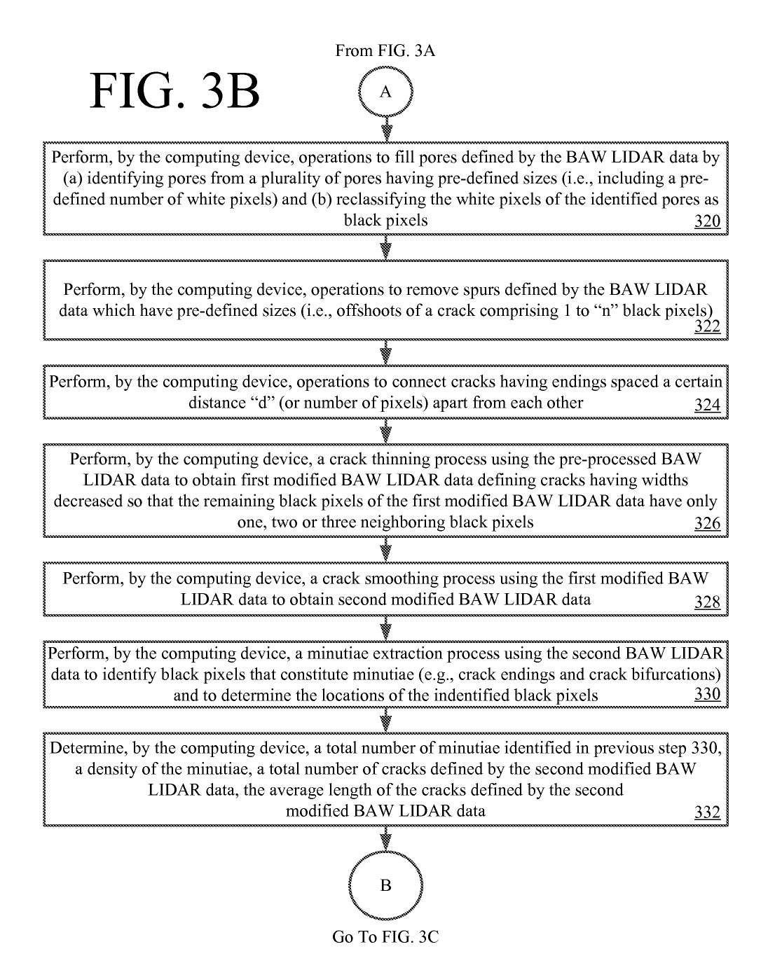

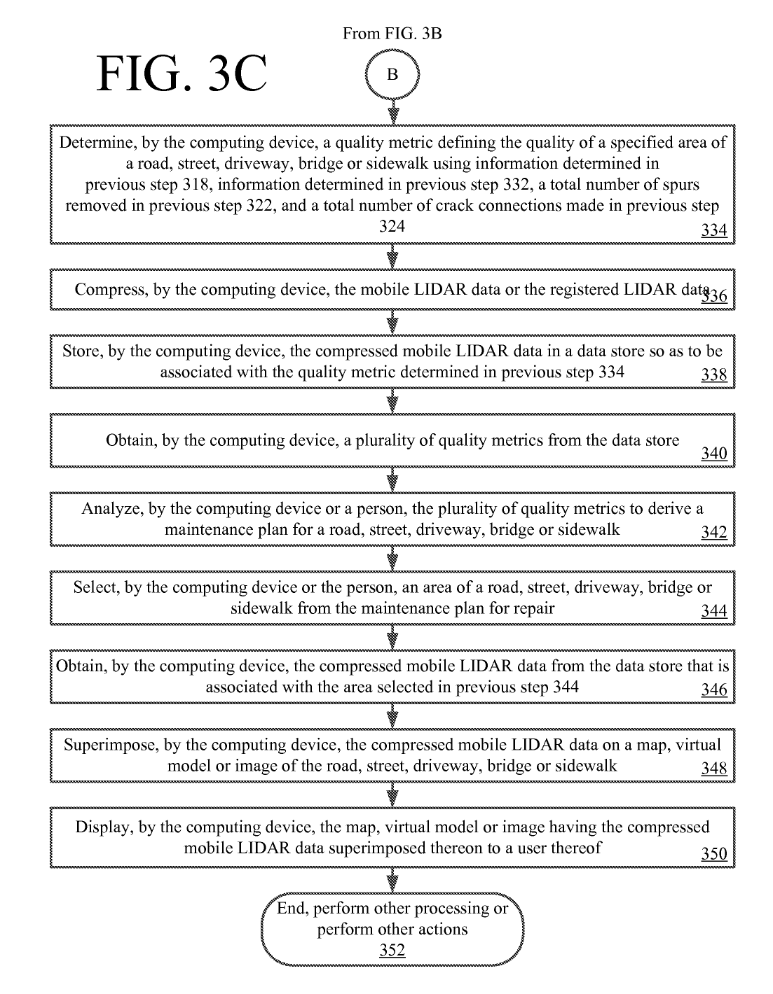

The present invention can be used in a variety of applications. Such applications include, but are not limited to, Department Of Transportation (“DOT”) applications and any other application in which cracks in a surface of a terrain needs to be identified. The terrain can include, but is not limited to, a road, a street, a driveway, a bridge and/or a sidewalk. Exemplary implementing system embodiments of the present invention will be described below in relation to FIGS. 1-2. Exemplary method embodiments of the present invention will be described below in relation to FIGS. 3A-12.

Exemplary Systems Implementing the Present Invention

Referring now to FIG. 1, there is provided a block diagram of an exemplary system 100 that is useful for understanding the present invention. The system 100 comprises a vehicle 102, a network 110, a computing device 112 and a database 114. The system 100 may include more, less or different components than those illustrated in FIG. 1. However, the components shown are sufficient to disclose an illustrative embodiment implementing the present invention. The hardware architecture of FIG. 1 represents one embodiment of a representative system configured to facilitate: (a) the automatic detection of cracks in surfaces of roads, streets, bridges, driveways, sidewalks and other terrain using mobile LIDAR data; and (b) the automatic generation of quality metrics useful for creating a maintenance plan for the roads, streets, bridges, driveways, sidewalks and other terrain. As such, system 100 implements a method for automatic crack detection and maintenance plan creation in accordance with embodiments of the present invention. The method will be described in detail below in relation to FIGS. 3A-12.

Referring again to FIG. 1, the vehicle 102 is a ground-based vehicle. The ground-based vehicle includes, but is not limited to, a car, van or truck. The vehicle 102 comprises LIDAR equipment 106 disposed thereon and communicatively coupled to a computing device 108 thereof. The LIDAR equipment is generally configured to collect LIDAR data as the vehicle 102 travels along a road, street, driveway, bridge, sidewalk or other terrain at a particular speed (e.g., 35 miles per hour). The LIDAR data comprises multidimensional grayscale data that defines the geometry of a surface of the road, street, driveway, bridge, sidewalk or other terrain. The multidimensional grayscale data can be three dimensional (“3D”) data or two and a half dimensional (“2.5D”) data. In either scenario, the mobile LIDAR data defines longitude values, latitude values and depths of points defining a geometry of a road, street, driveway, bridge, sidewalk or other terrain. Such LIDAR equipment is well known in the art, and therefore will not be described herein. Any known LIDAR equipment that is suitable for collecting LIDAR data defining a geometry of a surface can be used with the present invention without limitation. For example, the LIDAR equipment includes components for tracing a laser swath over a specified area of a terrain in order to obtain geographical information for said specified area. The LIDAR equipment may also have a resolution of approximately one millimeter (“1 mm”). Embodiments of the present invention are not limited in this regard. The LIDAR equipment can have any resolution selected in accordance with a particular application.

The vehicle 102 also has video equipment 116 attached thereto. The video equipment 116 is generally configured to generate mobile video data as the vehicle 102 travels along a road, street, driveway, bridge, sidewalk or other terrain. The video data includes, but is not limited to, two dimensional (“2D”) data that describes the geometry of a surface of the road, street, driveway, bridge, sidewalk or other terrain. Such video equipment is well known in the art, and therefore will not be described herein. Any such known video equipment that is suitable for collecting LIDAR data defining a geometry of a surface can be used with the present invention without limitation.

The LIDAR equipment 106 and/or video equipment 116 is also configured to communicate the respective data to the computing device 108 for processing and/or storage. The computing device 108 is disposed within the vehicle 102. The computing device 108 includes, but is not limited to, a notebook, a desktop computer, a laptop computer, a Personal Digital Assistant (“PDA”) or a tablet Personal Computer (“PC”). The computing device 108 is configured to communicate the received mobile LIDAR data and/or the received mobile video data to an external computing device 112 via a network 110. The external computing device 112 includes, but is not limited to, a server communicatively coupled to a database 114. The mobile LIDAR data and/or the mobile video data may be processed by the computing device 112 and/or stored in the database 114 for subsequently processing and/or analysis. The computing devices 108, 112 will be described in more detail below in relation to FIG. 2.

The processing performed by the computing device 108 and/or the computing device 112 generally involves operations for: registering the mobile LIDAR data and the mobile video data to each other; compressing at least the mobile LIDAR data; determining a quality metric for a specified area of a road, street, driveway, bridge, sidewalk or other terrain defined by the mobile LIDAR data; and storing the quality metric and the compressed mobile LIDAR data in a data store such that they are associated with each other. Image registration refers to the process of rotating and/or translating mobile LIDAR data and/or mobile video data such that said data is registered with each other. Exemplary image registration processes will be described below in relation to FIGS. 3A-3C. Data compression refers to the process of reducing the size of a computer file needed to store at least the mobile LIDAR data. Exemplary data compression processes will be described below in relation to FIGS. 3A-3C and FIGS. 11-12.

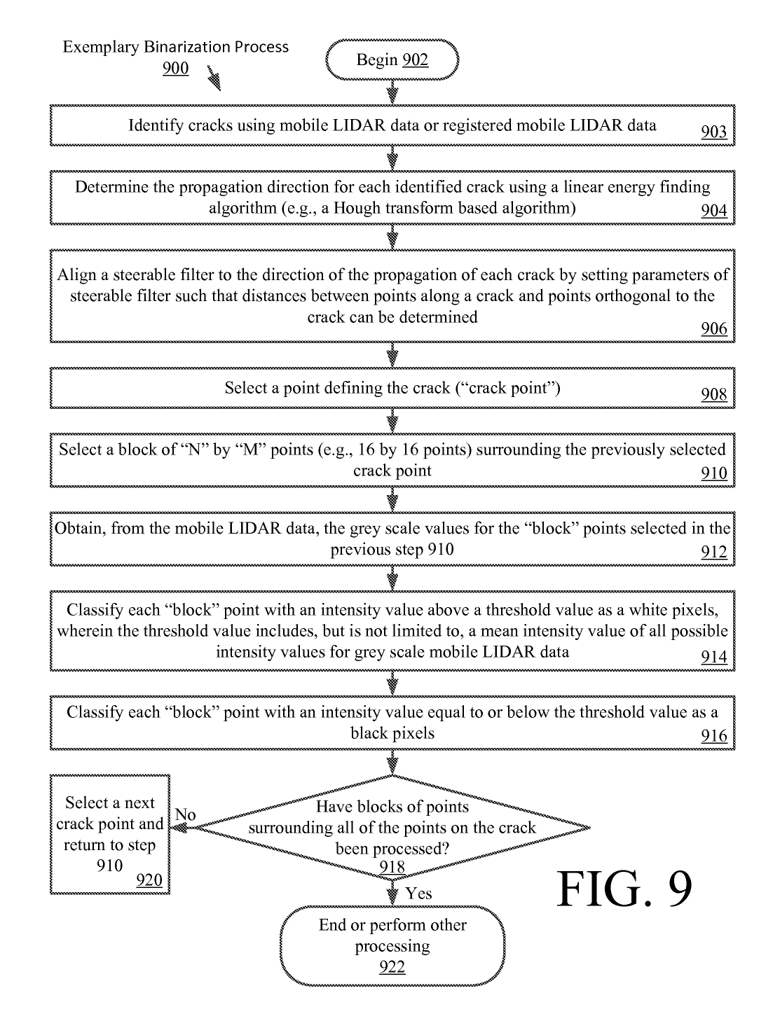

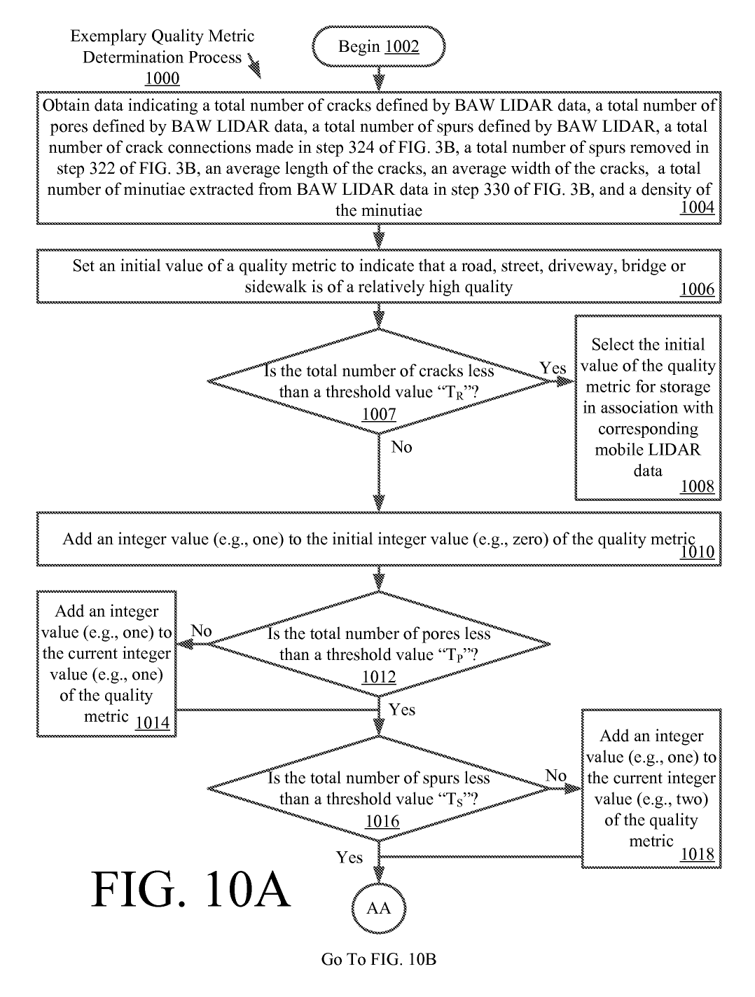

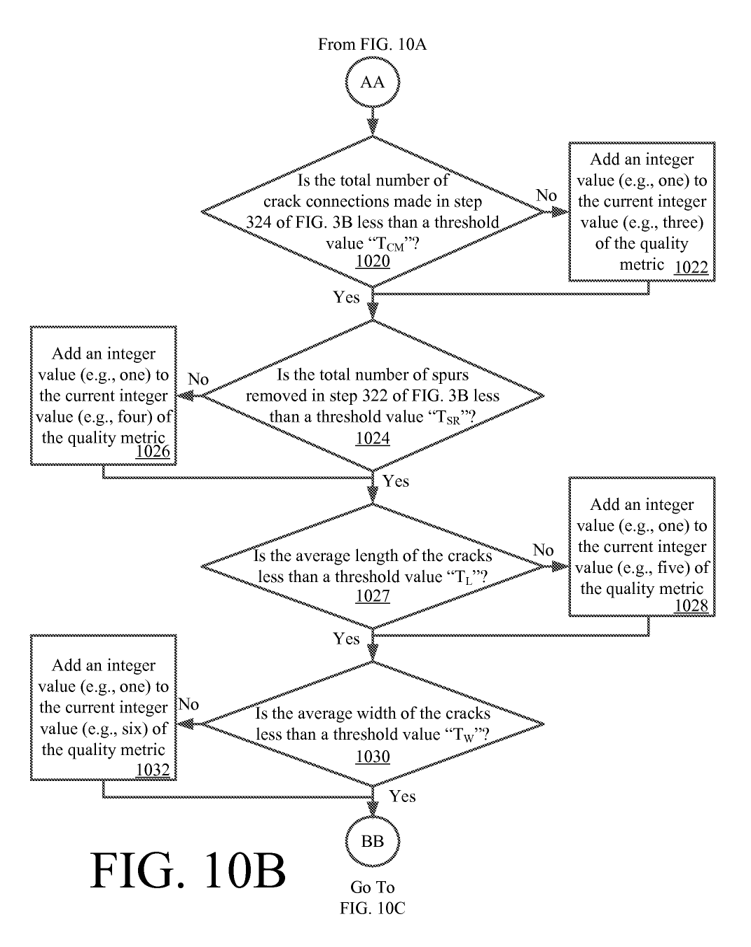

The quality metric based operations include, but are not limited to, image binarization operations, ridge thinning operations, minutiae extraction operations, quality metric generation operations, and various computational operations. Image binarization refers to the process of converting mobile LIDAR grayscale data to black-and-white data comprising points defining cracks in a road, street, driveway, bridge, sidewalk or other terrain. Exemplary image binarization processes will be described below in relation to FIGS. 3A-3C and FIG. 9. Ridge thinning refers to the process of decreasing the width of cracks such that each crack has a width of one pixel. Exemplary ridge thinning processes will be described below in relation to FIGS. 3A-3C.

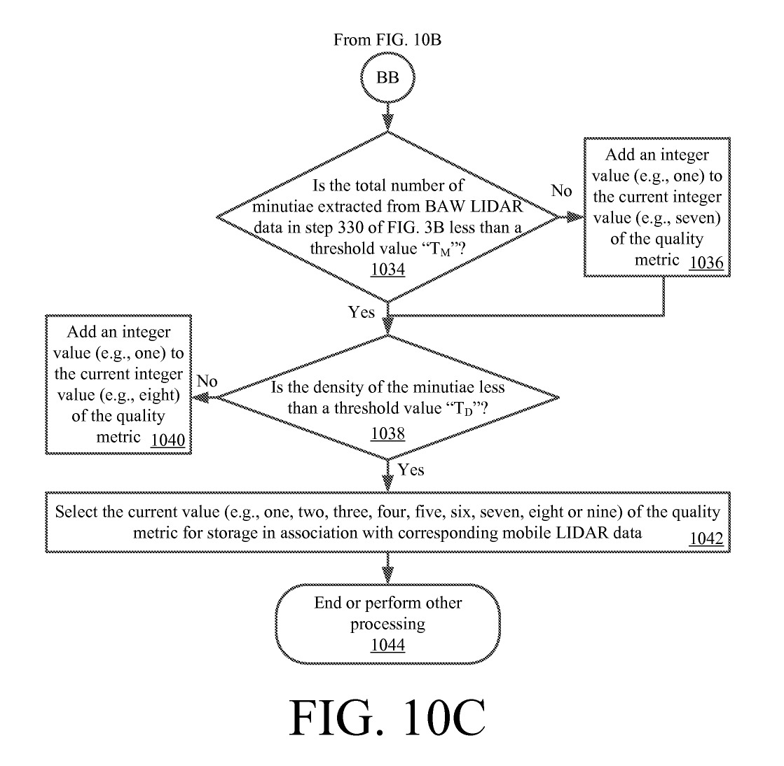

Minutiae extraction refers to the process of determining locations of points in the black-and-white data for crack endings and crack bifurcations. Each point location is defined by an “x-axis” value and a “y-axis” value. In some embodiments, each point may also be defined by an angle value. A ridge ending comprises a point of the black-and-white data with only one (1) neighboring point. A ridge bifurcation comprises a point of the black-and-white data with three (3) or more neighboring points. Exemplary minutiae extraction processes will be described below in relation to FIGS. 3A-3C. Quality metric generation refers to the process of determining a metric (e.g., an integer value between zero (0) and nine (9)) describing the quality of an area of a road, street, driveway, bridge, sidewalk or other terrain defined by mobile LIDAR data. Exemplary quality metric generation processes will be described below in relation to FIGS. 3A-3C and FIGS. 10A-10C.

The computations performed by computing device 108 and/or computing device 112 can involve, but are not limited to, computing a number of cracks in a specified area, a density of cracks in the specified area, the widths of the cracks, the lengths of the cracks, the depths of the cracks, a number of pores in the specified area, a number of spurs in the specified area, crack flow disturbances and a number of cracks that are connected together. The listed types of computations will be described below in relation to FIGS. 3A-3C. However, it should be understood that the results of said computations are used during the quality metric generation operations to determine the quality metric. More particularly, the results of some or all of the computations are compared to threshold values for determining if a specified area of a road, street, driveway, bridge, sidewalk or other terrain defined by mobile LIDAR data is of a relatively good condition or a relatively bad condition.

Referring now to FIG. 2, there is provided a block diagram of an exemplary computing device 200. Each of the computing devices 108 and 112 of FIG. 1 can be the same as or similar to computing device 200. As such, the following discussion of computing device 200 is sufficient for understanding computing devices 108 and 112 of FIG. 1. Notably, some or all the components of the computing device 200 can be implemented as hardware, software and/or a combination of hardware and software. The hardware includes, but is not limited to, one or more electronic circuits.

Notably, the computing device 200 may include more or less components than those shown in FIG. 2. However, the components shown are sufficient to disclose an illustrative embodiment implementing the present invention. The hardware architecture of FIG. 2 represents one embodiment of a representative computing device configured to facilitate the provision of computer files including data specifying cracks in surfaces of roads, streets, bridges, driveways, sidewalks and/or other terrain, and the provision of quality metrics that are useful for creating a maintenance plan for the roads, streets, bridges, driveways, sidewalks, and/or other terrain. As such, the computing device 200 of FIG. 2 implements an improved method for crack detection and maintenance creation in accordance with embodiments of the present invention. Exemplary embodiments of the improved method will be described below in relation to FIGS. 3A-12.

As shown in FIG. 2, the computing device 200 comprises an antenna 202 for receiving and transmitting communication signals (e.g., Radio Frequency (“RF”) signal). A receive/transmit (Rx/Tx) switch 204 selectively couples the antenna 202 to the transmitter circuitry 206 and receiver circuitry 208 in a manner familiar to those skilled in the art. The receiver circuitry 208 decodes the communication signals received from an external communication device to derive information therefrom. The receiver circuitry 208 is coupled to a controller 260 via an electrical connection 234. The receiver circuitry 208 provides decoded communication signal information to the controller 260. The controller 260 uses the decoded communication signal information in accordance with the function(s) of the computing device 200. The controller 260 also provides information to the transmitter circuitry 206 for encoding information and/or modulating information into communication signals. Accordingly, the controller 260 is coupled to the transmitter circuitry 206 via an electrical connection 238. The transmitter circuitry 206 communicates the communication signals to the antenna 202 for transmission to an external device.

An antenna 240 is coupled to Global Positioning System (“GPS”) receiver circuitry 214 for receiving GPS signals. The GPS receiver circuitry 214 demodulates and decodes the GPS signals to extract GPS location information therefrom. The GPS location information indicates the location of the computing device 200. The GPS receiver circuitry 214 provides the decoded GPS location information to the controller 260. As such, the GPS receiver circuitry 214 is coupled to the controller 260 via an electrical connection 236. Notably, the present invention is not limited to GPS based methods for determining a location of the computing device 200. Other methods for determining a location of a communication device can be used with the present invention without limitation.

The controller 260 uses the decoded GPS location information in accordance with the function(s) of the computing device 200. For example, the GPS location information and/or other location information can be used to generate a geographic map showing the location of the computing device 200. The GPS location information and/or other location information can also be used to determine the actual or approximate distance between the computing device 200 and other devices or landmarks (e.g., a bridge, intersection or interstate exit). The GPS location information and/or other location information can further be associated with mobile LIDAR data acquired by LIDAR equipment (e.g., LIDAR equipment 106 of FIG. 1) and/or mobile video data acquired by video equipment (e.g., video equipment 116) such that the locations of detected cracks in roads, streets, bridges, driveways, sidewalks and/or other terrain can be known.

The controller 260 stores the decoded RF signal information and the decoded GPS location information in its internal memory 212. Accordingly, the controller 260 comprises a Central Processing Unit (“CPU”) 210 that is connected to and able to access the memory 212 through an electrical connection 232. The memory 212 can be a volatile memory and/or a non-volatile memory. For example, the memory 212 can include, but is not limited to, a Random Access Memory (RAM), a Dynamic Random Access Memory (DRAM), a Static Random Access Memory (SRAM), Read-Only Memory (ROM) and flash memory. The memory 212 can also have stored therein software applications 252, mobile LIDAR data (not shown in FIG. 2) and/or mobile video data (not shown in FIG. 2). The software applications 252 include, but are not limited to, applications operative to provide crack detection services, maintenance plan creation services, location services, position reporting services, web based services, and/or communication services.

As shown in FIG. 2, the controller 260 also comprises a system interface 218, a user interface 230, and hardware entities 232. System interface 218 allows the computing device 200 to communicate directly with external devices (e.g., the LIDAR equipment 106 of FIG. 1, video equipment 116 of FIG. 1, network equipment and other computing devices) via a wired or wireless communications link.

At least some of the hardware entities 232 perform actions involving access to and use of memory 212. In this regard, hardware entities 232 may include microprocessors, Application Specific Integrated Circuits (“ASICs”) and other hardware. Hardware entities 232 may include a microprocessor programmed for facilitating the provision of crack detection services, maintenance plan creation services, location services, position reporting services, web based services, and/or communication services to users of the computing device 200. In this regard, it should be understood that the microprocessor can access and run applications 252 installed on the computing device 200.

As shown in FIG. 2, the hardware entities 232 can include a disk drive unit 234 comprising a computer-readable storage medium 236 on which is stored one or more sets of instructions 250 (e.g., software code) configured to implement one or more of the methodologies, procedures, or functions described herein. The instructions 250 can also reside, completely or at least partially, within the memory 212 and/or within the CPU 210 during execution thereof by the computing device 200. The memory 212 and the CPU 210 also can constitute machine-readable media. The term “machine-readable media”, as used here, refers to a single medium or multiple media (e.g., a centralized or distributed database, and/or associated caches and servers) that store the one or more sets of instructions 250. The term “machine-readable media”, as used here, also refers to any medium that is capable of storing, encoding or carrying a set of instructions 250 for execution by the computing device 200 and that cause the computing device 200 to perform any one or more of the methodologies of the present disclosure.

The user interface 230 comprises input devices 216 and output devices 224. The input devices 216 include, but are not limited to, a keypad 220 and a microphone. The output devices 224 include, but are not limited to, a speaker 226 and a display 228. During operation, LIDAR data can be superimposed on a map, virtual model or image of a road, street, driveway, bridge, sidewalk or other terrain in an imagery viewer (e.g., a virtual globe viewer “Google Earth”). In this regard, the LIDAR data is stored such that points thereof have at least latitude, longitude and depth values associated therewith. The superimposition can be achieved using a mark-up language, such as a Keyhole Markup Language (“KML”), or other software language. The result of the superimposing operations may then be presented to the user of the computing device 200 via the display 228.

As evident from the above discussion, the system 100 implements one or more method embodiments of the present invention. The method embodiments of the present invention can be used in systems employing mobile LIDAR data or other mobile multi-dimensional data identifying cracks in roads, streets, driveways, bridges, sidewalks and/or other terrain. Exemplary method embodiments of the present invention will now be described in relation to FIGS. 3A-12.

### Exemplary Methods of The Present Invention

Referring now to FIGS. 3A-3C, there is provided a flow diagram of an exemplary method 300 for automatic crack detection and maintenance plan creation that is useful for understanding the present invention. As shown in FIG. 3A, method 300 begins with step 302 and continues with step 303. In step 303, location information (e.g., GPS information) is acquired by a computing device (e.g., computing device 108 or 112 of FIG. 1). The location information indicates the current location of a vehicle (e.g., the vehicle 102 of FIG. 1) traveling along a road, street, driveway, bridge, sidewalk or other terrain. The location information includes, but is not limited to, latitude information and longitude information.

In a next step 304, mobile LIDAR data is acquired by LIDAR equipment (e.g., LIDAR equipment 106 of FIG. 1) disposed on the vehicle. Similarly, step 306 is performed where mobile video data is optionally acquired by video equipment (e.g., video equipment 116 of FIG. 1) disposed on the vehicle. The mobile LIDAR data and the mobile video data describe a geometry of a surface of a road, street, driveway, bridge, sidewalk or other terrain. Thereafter, the mobile LIDAR data and the mobile video data are communicated to the computing device, as shown by step 308. In step 310, the computing device performs operations to store the mobile LIDAR data and the mobile video data in a data store (e.g., database 114 of FIG. 1 or memory 212 of FIG. 2) such that points thereof are associated with respective location information acquired in previous step 303.

Upon completing step 310, optional step 312 is performed where the computing device performs an image registration process for registering the mobile LIDAR data and the mobile video data with each other. Registration techniques are well known in the art for registering two (2) types of data with each other. Any such technique can be used with the present invention without limitation. One such technique generally involves: identifying tie points or common corresponding points in the mobile LIDAR data and mobile video data; identifying which tie points are key points (i.e., points that describe robust features that exist in the data such as a corner or bend in a road); determining rotation and translation values for the mobile LIDAR data and/or the mobile video data using the location information (e.g., “x-axis” and “y-axis” values) associated with the key points; and generating registered mobile LIDAR data and/or mobile video data using the previously determined rotation and translation values. Embodiments of the present invention are not limited in this regard. For example, an Iterative Closest Point (“ICP”) algorithm can be additionally or alternatively employed to register the mobile LIDAR data and the mobile video data to each other. ICP algorithms are well known, and therefore will not be described here. Notably, the registered mobile LIDAR data and/or mobile video data may be stored in the data store for subsequent use, as shown by step 314.

In a next step 316, the computing device performs a binarization process using the mobile LIDAR data or the registered mobile LIDAR data to obtain Black-And-White (“BAW”) LIDAR data comprising black pixels and white pixels. The black pixels of the BAW LIDAR data collectively define cracks in a specified area of a road, street, driveway, bridge, sidewalk or other terrain. An exemplary embodiment of the binarization process will be described below in relation to FIG. 9. However, it should be understood that the binarization process involves converting grey scale mobile LIDAR data to the BAW LIDAR data. This conversion is generally achieved using a steerable filter which is aligned or nearly aligned to the propagation directions of the cracks defined by the mobile LIDAR data. Steerable filters are well known in the art, and therefore will not be described herein. Any such steerable filter can be used with the present invention without limitation.

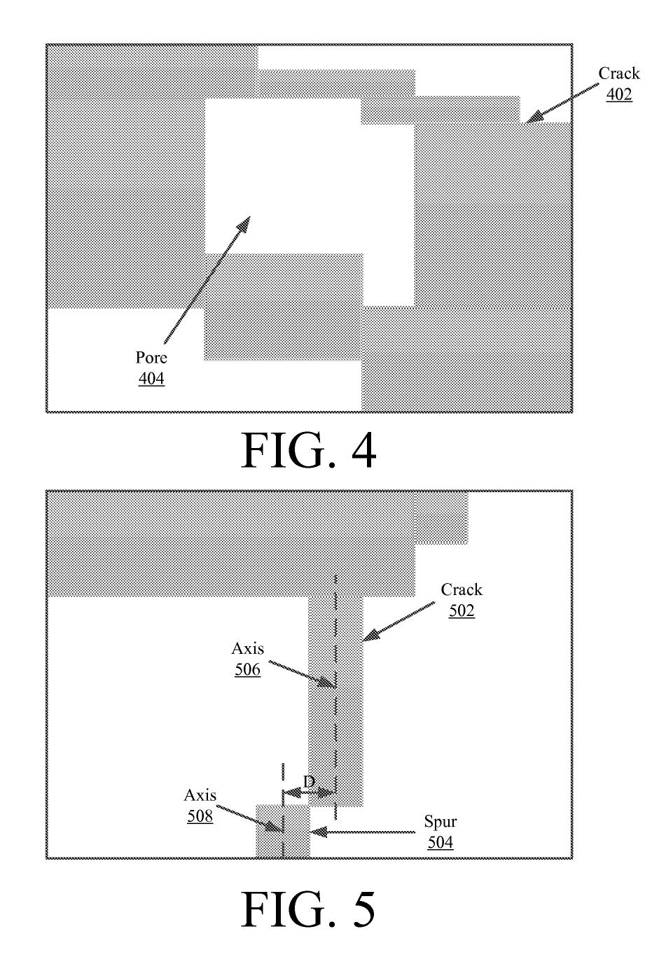

The BAW LIDAR data is then analyzed in step 318 to determine an average width of the cracks, a total number of pores and a total number of spurs for use in a subsequent quality metric determination process. A schematic illustration of a pore is provided in FIG. 4. As shown in FIG. 4, a pore 404 comprises an island of white pixels having a predetermined size (e.g., an island or a patch including sixteen (16) white pixels) that is encompassed by black pixels of a crack 402. A schematic illustration of a spur is provided in FIG. 5. As shown in FIG. 5, a spur 504 comprises at least one black pixel having a central axis 508 that is offset a certain distances D from a central axis 506 of black pixels of a crack 502. Notably, a spur can include any number of black pixels selected in accordance with a particular application.

Referring again to FIG. 3A, the method 300 continues with step 320 of FIG. 3B. Step 320 involves performing operations by the computing device to fill some or all of the pores defined by the BAW LIDAR data. The pore filling is achieved by: identifying pores from a plurality of pores that have pre-determined sizes (i.e., including a pre-defined number of white pixels); and reclassifying (filling) the white pixels of the identified pores as black pixels.

After the pores have been filled, step 322 is performed where some or all of the spurs defined by the BAW LIDAR data are removed by the computing device. The spur removal is achieved by: identifying spurs from a plurality of spurs that have pre-defined sizes (i.e., include a pre-defined number of black pixels); and reclassifying the black pixels of the identified spurs as white pixels.

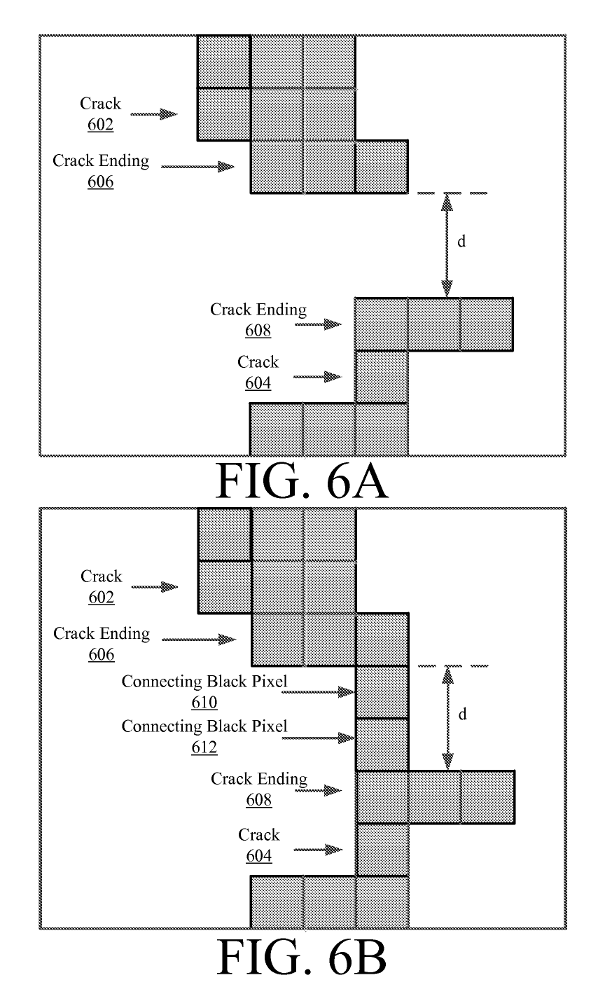

In a next step 324, the computing device performs operations to connect cracks having endings that are spaced a certain distance (or a number of white pixels) apart from each other. These crack connecting operations will now be described in relation to FIGS. 6A-6B.

FIG. 6A is a schematic illustration of two (2) cracks 602, 604 having endings 606, 608 that are spaced a distance d from each other, i.e., there are one or more white pixels separating the black pixels defining the endings 606, 608 of the cracks 602, 604. FIG. 6A is a schematic illustration of the two (2) cracks 602, 604 of FIG. 6A being connected to each other. The connection is achieved by: identifying the white pixels which reside between the endings 606, 608 of the cracks 602, 604; and reclassifying at least some of the identified white pixels as connecting black pixels 610, 612.

Referring again to FIG. 3B, the method 300 continues with step 326 which involves performing a crack thinning process by the computing device using the pre-processed BAW LIDAR data to obtain first modified BAW LIDAR data. The pre-processed BAW LIDAR data includes the data resulting from the operations performed in previous steps 316 and 320-324. The first modified BAW LIDAR data defines cracks having widths of one pixel.

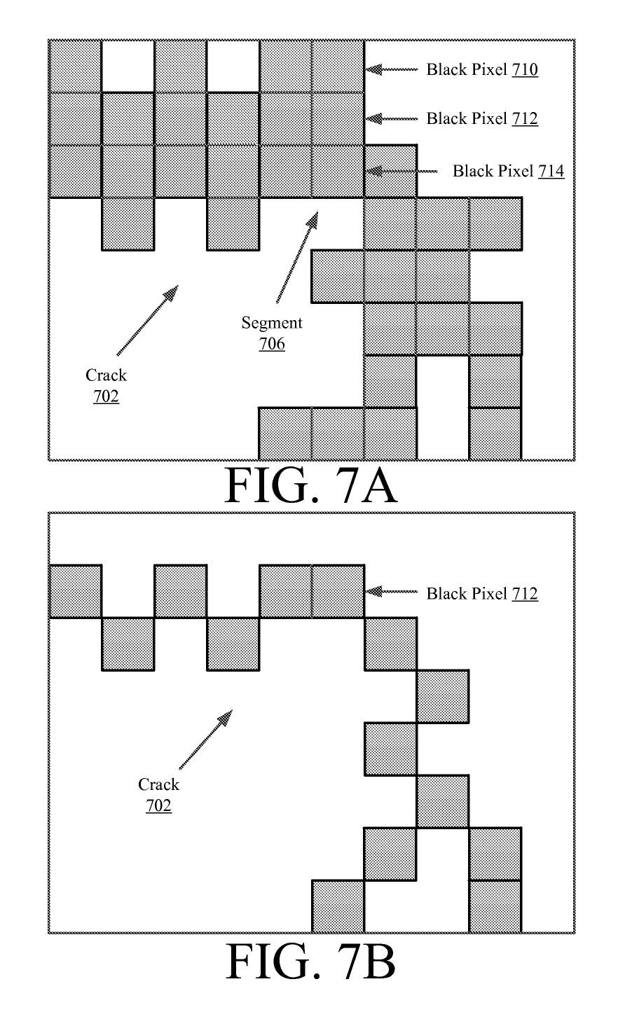

The crack thinning process will now be described in relation to FIGS. 7A-7B. FIG. 7A is a schematic illustration of a crack 702 having a relatively large width. For example, the crack 702 is generally two (2) or more black pixels wide. FIG. 7B is a schematic illustration of the crack 702 having a relatively thin width. For example, the crack 702 is reduced to one (1) black pixel wide. The width of the crack 702 is thinned by using a chamfering process to decrease its width so that the remaining black points thereof have only one (1) neighboring black point. Chamfering processes are well known in the art, and therefore will not be described in detail herein. Any such chamfering process can be used with the present invention without limitation. One such chamfering process generally involves: discarding a plurality of black points defining a crack. The black points which are discarded are the outer most black points defining segments of the crack. For example, as shown in FIGS. 7A-7B, if three black points 710, 712, 714 define a segment 706 of a crack 702, then the outermost segments 710 and 714 are discarded. Notably, pores are removed as a result of the performance of the pore filling process of step 320 and the crack thinning process of step 326.

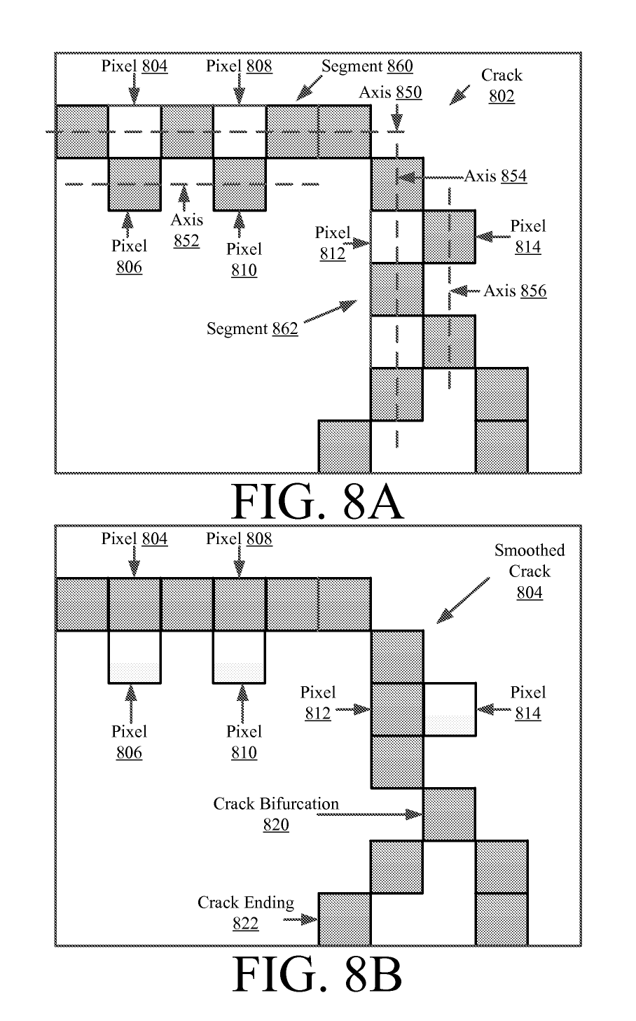

Referring again to FIG. 3B, the method 300 continues with step 328 where a crack smoothing process is performed by the computing device using the first modified BAW LIDAR data to obtain second modified BAW LIDAR data. The crack smoothing process is generally performed to reduce a pixel-wide noise of the first modified BAW LIDAR data so as to obtain second modified BAW LIDAR data with smoothed cracks. The crack smoothing process will now be described in relation to FIGS. 8A-8B. FIG. 8A is a schematic illustration of an unsmoothed crack 802 in which central axis 850, 852, 854, 856 of black pixels of respective segments 860, 862 are not aligned with each other. FIG. 8B is a schematic illustration of a smoothed crack 804 in which the central axis 850, 852, 854, 856 of black pixels of respective segments 860, 862 are aligned with each other. The axis alignment is generally achieved by: identifying one or more segments 860, 862 of a crack 802; identifying black pixels 806, 810, 814 of the segments 860, 862 whose central axes 852, 856 are offset from the central axes 850, 854 of a majority of the black pixels defining the crack 802; identifying white pixels 804, 808, 812 whose central axes are aligned with the central axis 850, 854 of the majority of the black pixels defining the crack 802; reclassifying the identified black pixels 806, 810, 814 as white pixels; and reclassifying the identified white pixels 804, 808, 812 as black pixels.

Referring again to FIG. 3B, the method 300 continues with step 330 in which a minutiae extraction process is performed by the computing device using the second BAW LIDAR data. The minutiae extraction process is performed to identify black pixels defining cracks that constitute minutiae. The minutiae extraction process is also performed to determine the locations of the identified black pixels. Minutiae extraction processes are well known in the art, and therefore will not be described here in detail. Any such known minutiae extraction process can be used with the present invention without limitation. However, it should be understood that the minutiae includes, but is not limited to, crack endings and crack bifurcations. A schematic illustration of a crack ending and a crack bifurcation is provided in FIG. 8B. As shown in FIG. 8B, a crack ending 822 includes a black pixel with only one (1) neighboring black pixel. A crack bifurcation 820 includes a black pixel with three (3) neighboring black pixels. However, in other embodiments, crack bifurcation 820 may include more than three (3) neighboring black pixels.

Upon completing step 330 of FIG. 3B, step 332 is performed. In step 332, the computing device determines a total number of minutiae identified in previous step 330, a density of the minutiae, a total number of cracks defined by the second modified BAW LIDAR data, and the average length of the cracks defined by the second modified BAW LIDAR data for use in a subsequent quality metric determination process. After completing step 332, the method 300 continues with step 334 of FIG. 3C.

Step 334 involves determining a quality metric by the computing device. The quality metric defines the quality of a specified area of a road, street, driveway, bridge or sidewalk. The quality metric is obtained using information determined in previous step 318, information determined in previous step 332, a total number of spurs removed in previous step 332, and a total number of crack connections made in previous step 324. The quality metric may also be obtained using information specifying the depths of the cracks and/or ridge flow disturbances (e.g., floating point calculations of directionality of cracks). An exemplary method for determining the quality metric will be described in detail below in relation to FIGS. 10A-10C.

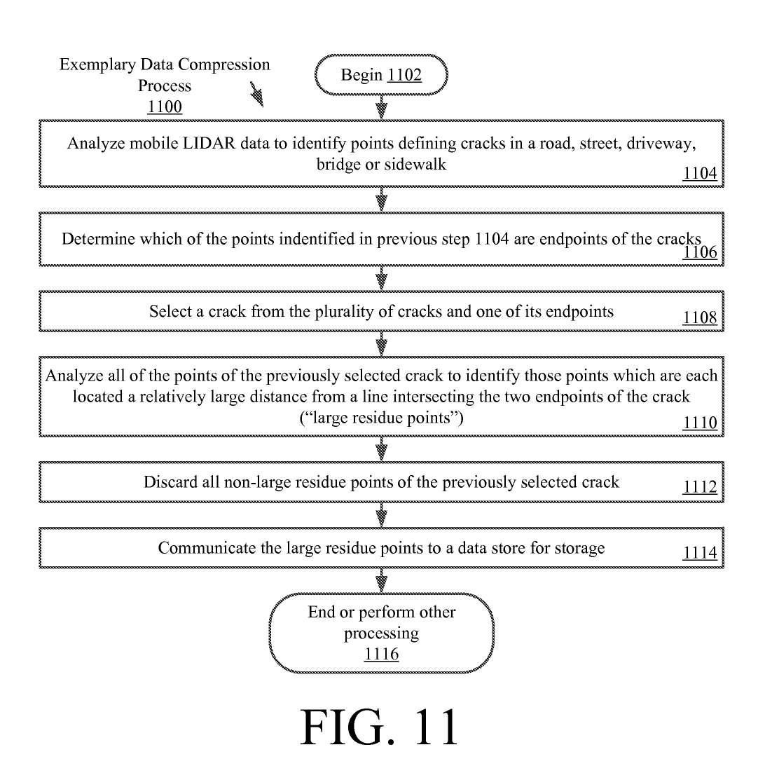

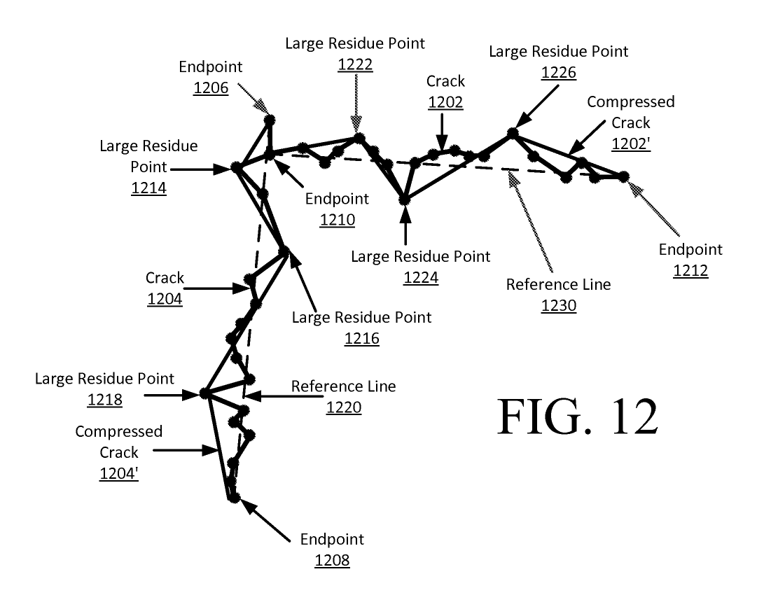

In a next step 336, the mobile LIDAR data or the registered mobile LIDAR data is compressed. Data compression techniques are well known in the art. Any such data compression technique can be used with the present invention without limitation. One exemplary data compression technique will be described below in relation to FIGS. 11-12. However, it should be understood that the data compression is performed to reduce the size of a computer file needed to store the mobile LIDAR data. The size reduced computer file or compressed mobile LIDAR data is then stored by the computing device in the data store so as to be associated with the quality metric determined in previous step 334, as shown by step 338.

Upon completing step 338, steps 340-342 are performed to determine a maintenance plan for repairing a road, street, driveway, bridge or sidewalk. In step 340, the computing device obtains a plurality of quality metrics from the data store. The quality metrics are analyzed in step 342 to derive the maintenance plan. In embodiments of the present invention, the maintenance plan lists areas of roads, streets, driveways, bridges, sidewalks and/or other terrain in accordance with their associated quality metrics. For example, first areas having quality metrics of nine (9) appear at the top of the list. Second areas having quality metrics of eight (8) appear directly below the first areas on the list, and so on. In this scenario, a quality metric of nine (9) indicates that a first area is of a relative low quality, and therefore should be repaired prior to other areas having quality metrics equal to or less than eight (8). In contrast, a quality metric of zero (0) indicates that an area is of a relatively high quality, and therefore should be repaired only after other areas having quality metrics equal to or greater than one (1) have been repaired. Embodiments of the present invention are not limited in this regard.

Referring again to FIG. 3C, steps 344-352 are performed to repair an area of a road, street, driveway, bridge, sidewalk or other terrain. As such, step 344 involves selecting an area of a road, street, driveway, bridge, sidewalk or other terrain from the maintenance plan for repair. The area can be selected automatically by the computing device or manually by a person. In the next step 346, compressed mobile LIDAR data is obtained from the data store. The compressed mobile LIDAR data obtained in step 346 includes data that is associated with the area selected in previous step 344. Thereafter in step 348, the compressed mobile LIDAR data is superimposed on a map, virtual model or image of the road, street, driveway, bridge, sidewalk or other terrain. The map, virtual model or image having the compressed mobile LIDAR data superimposed thereon is then displayed by the computing device, as shown by step 350. Subsequently, step 352 is performed where the method ends, other processing is performed, or other actions are performed. The other actions can involve, but are not limited to, repairing the area of the road, street, driveway, bridge, sidewalk or other terrain using the information provided by the displayed map, virtual model or image.

Referring now to FIG. 9, there is provided a flow diagram of an exemplary binarization process 900 that is useful for understanding the present invention. As shown in FIG. 9, the binarization process 900 begins with step 902 and continues with step 903. Step 903 involves identifying cracks using mobile LIDAR data or registered mobile LIDAR data. In a next step 904, the propagation directions are determined for each identified crack. The propagation directions are determined using a linear energy finding algorithm. Linear energy finding algorithms are well known in the art, and therefore will not be described herein. Any such linear energy finding algorithm can be used with the present invention without limitation. For example, a Hough transform based algorithm is used in step 904 to determine the propagation directions of the cracks. Hough transform based algorithms are well known, and therefore will not be described herein. Embodiments of the present invention are not limited in this regard.

Thereafter, step 906 is performed where a steerable filter is aligned to the direction of propagation of each crack. The steerable filter is aligned by setting parameters thereof such that distances between points along a crack defined by the mobile LIDAR data and points orthogonal to the crack can be determined. Steerable filters are well known in the art, and therefore will not be described herein. Any such steerable filter can be used with the present invention without limitation.

After aligning the steerable filter, the binarization process 900 continues with steps 908-916. Steps 908-916 are performed by the steerable filter. Step 908 involves selecting a point defining the crack (“crack point”). Step 910 involves selecting a block of “N” by “M” points (“block points”) surrounding the previously selected crack point, where “N” and “M” are integer values. “N” and “M” can be any integer value selected in accordance with a particular application. “N” and “M” can also be selected as the same or different integer values. For example, in a first scenario, both “N” and “M” are selected to be equal to sixteen (16). In a second scenario, only “N” is selected to be equal to sixteen (16). Embodiments of the present invention are not limited in this regard.

Step 912 involves obtaining from the mobile LIDAR data the grey scale values for the block points. Thereafter, the intensity value for each block point is compared to a threshold value, as shown by steps 914 and 916. The threshold value includes, but is not limited to, a mean intensity value of all possible intensity values for grey scale mobile LIDAR data. Block points having intensity values above the threshold value are classified as white pixels. In contrast, block points having intensity values equal to or less than the threshold value are classified as black pixels.

After completing step 916, a decision step 916 is performed to determine if blocks of points surrounding all of the points on the crack have been processed. If blocks of points surrounding all of the points on the crack have not been processed [918:NO], then step 920 is performed where a next crack point is selected and the binarization process 900 returns to step 910. If blocks of points surrounding all of the points on the crack have been processed [918:YES], then step 922 is performed where the binarization process 900 ends or other processing is performed.

Referring now to FIGS. 10A-10C, there is provided a flow diagram of an exemplary quality metric determination process 1000 that is useful for understanding the present invention. Process 1000 begins with step 1002 and continues with step 1004. Step 1004 involves obtaining data indicating a total number of cracks defined by BAW LIDAR data, a total number of pores defined by BAW LIDAR data, a total number of spurs defined by BAW LIDAR data, a total number of crack connections made in step 324 of FIG. 3B, a total number of pores filled in step 322 of FIG. 3B, an average length of the cracks, an average width of the cracks, a total number of minutiae extracted from BAW LIDAR data in step 330 of FIG. 3B, and a density of minutiae. In a next step 1006, an initial value of a quality metric is set to indicate that a road, street, driveway, bridge, sidewalk or other terrain is of a relatively high quality. For example, the initial value of the quality metric is set to be zero (0).

Upon the completion of step 1006, a decision step 1007 is performed to determine if the total number of cracks is less than a threshold value T_{R}. If the total number of cracks is less than a threshold value T_{R} [1006:YES], then step 1008 is performed where the initial value of the quality metric is selected for storage in association with corresponding mobile LIDAR data. If the total number of cracks is not less than a threshold value T_{R} [1006:NO], then step 1010 is performed where an integer value (e.g., one) is added to the initial integer value (e.g., zero) of the quality metric.

Thereafter, another decision step 1012 is performed to determine if the total number of pores is less than a threshold value T_{P}. If the total number of pores is less than a threshold value T_{R} [1012:YES], then a decision step 1016 is performed. Decision step 1016 will be described below. If the total number of pores is not less than a threshold value T_{R} [1012:NO], then step 1014 is performed where an integer value (e.g., one) is added to the current integer value (e.g., one) of the quality metric. Next, decision step 1016 is performed.

Decision step 1016 is performed to determine if the total number of spurs is less than a threshold value T_{S}. If the total number of spurs is less than a threshold value T_{S} [1016:YES], then a decision step 1020 of FIG. 10B is performed. Decision step 1020 will be described below. If the total number of spurs is not less than a threshold value T_{S} [1016:NO], then step 1018 is performed where an integer value (e.g., one) is added to the current integer value (e.g., two) of the quality metric. Next, decision step 1020 is performed.

Decision step 1020 is performed to determine if the total number of crack connections made in step 324 of FIG. 3B is less than a threshold value T_{CM}. If the total number of crack connections made in step 324 of FIG. 3B is less than the threshold value T_{CM} [1020:YES], then a decision step 1024 is performed. Decision step 1024 will be described below. If the total number of crack connections made in step 324 of FIG. 3B is not less than the threshold value T_{CM} [1024:NO], then step 1022 is performed where an integer value (e.g., one) is added to the current integer value (e.g., three) of the quality metric. Next, decision step 1024 is performed.

Decision step 1024 is performed to determine if the total number of spurs removed in step 322 of FIG. 3B is less than a threshold value T_{SR}. If the total number of spurs removed in step 322 of FIG. 3B is less than the threshold value T_{SR} [1024:YES], then a decision step 1026 is performed. Decision step 1024 will be described below. If the total number of spurs removed in step 322 of FIG. 3B is not less than the threshold value T_{SR} [1024:NO], then step 1026 is performed where an integer value (e.g., one) is added to the current integer value (e.g., four) of the quality metric. Next, decision step 1027 is performed.

Decision step 1027 is performed to determine if the average length of the cracks is less than a threshold value T_{L}. If the average length of the cracks is less than the threshold value T_{L} [1027:YES], then a decision step 1030 is performed. Decision step 1030 will be described below. If the average length of the cracks is not less than the threshold value T_{L} [1027:NO], then step 1028 is performed where an integer value (e.g., one) is added to the current integer value (e.g., five) of the quality metric. Next, decision step 1030 is performed.

Decision step 1030 is performed to determine if the average width of the cracks is less than a threshold value T_{W}. If the average width of the cracks is less than the threshold value T_{W} [1030:YES], then a decision step 1034 of FIG. 10C is performed. Decision step 1034 will be described below. If the average width of the cracks is not less than the threshold value T_{W} [1030:NO], then step 1032 is performed where an integer value (e.g., one) is added to the current integer value (e.g., six) of the quality metric. Next, decision step 1034 of FIG. 10C is performed.

Decision step 1034 is performed to determine if the total number of minutiae extracted from BAW LIDAR data in step 330 of FIG. 3B is less than a threshold value T_{M}. If the total number of minutiae extracted from BAW LIDAR data in step 330 of FIG. 3B is less than the threshold value T_{M} [1034:YES], then a decision step 1038 is performed. Decision step 1038 will be described below. If the total number of minutiae extracted from BAW LIDAR data in step 330 of FIG. 3B is not less than the threshold value T_{M} [1034:NO], then step 1036 is performed where an integer value (e.g., one) is added to the current integer value (e.g., seven) of the quality metric. Next, decision step 1038 is performed.

Decision step 1038 is performed to determine if the density of the minutiae is less than a threshold value T_{D}. If the density of the minutiae is not less than the threshold value T_{D} [1038:NO], then step 1040 is performed where an integer value (e.g., one) is added to the current integer value (e.g., eight) of the quality metric. Thereafter, step 1042 is performed. Step 1042 will be described below. If density of the minutiae is less than the threshold value T_{D} [1038:YES], then step 1042 is performed. Step 1042 involves selecting a current value (e.g., one, two, three, four, five, six, seven, eight or nine) of the quality metric for storage in association with corresponding mobile LIDAR data. Subsequent to completing step 1042, step 1044 is performed where process 1000 ends or other processing is performed.

Referring now to FIG. 11, there is provided a flow diagram of an exemplary data compression process 1100 that is useful for understanding the present invention. Process 1100 begins with step 1102 and continues with step 1104. Step 1104 involves analyzing mobile LIDAR data to identify points defining cracks in a road, street, driveway, bridge, sidewalk or other terrain. In a next step 1106 a determination is made. In particular, it is determined which of the points identified in previous step 1104 are endpoints of the cracks. Thereafter, a crack is selected from a plurality of cracks, as shown by step 1108. Also, one (1) of the crack's endpoints is selected in step 1108. In step 1110, all of the points of the previously selected crack are analyzed to identify those points which are “large residue points”. A “large residue point” can include a point which is located a relatively large distance from a reference line intersecting the two (2) endpoints of the crack. Alternatively or additionally, a set of large residue points can comprise two (2) points which have the greatest offset between their vertical axes if the corresponding crack propagates in a vertical direction or their horizontal axes if the corresponding crack propagates in a horizontal direction. The point analysis of step 1110 begins with the endpoint selected in previous step 1108, and continues with the endpoints neighbor point of the crack. After analyzing each point of the crack, all non-large residue points of the crack are discarded, as shown by step 1112. In contrast, all large residue points of the crack are stored in a data store, as shown by step 1114. The large residue points comprise compressed mobile LIDAR data. Subsequent to completing step 1114, step 1116 is performed where the process 1100 ends or other processing is performed.

A schematic illustrating process 1100 is provided in FIG. 12. Two (2) cracks 1202, 1204 are shown in FIG. 12. Crack 1202 propagates in a horizontal direction. Crack 1204 propagates in a vertical direction. Each crack 1202, 1204 comprises a plurality of points. Also, each crack 1202, 1204 comprises two (2) respective endpoints 1206, 1208 or 1210, 1212. A reference line 1220, 1230 is drawn between the endpoints 1206, 1208 or 1210, 1212 of a respective crack 1202, 1204. The reference line 1220, 1230 may be used to determine which points of the crack 1202, 1204 are large residue points. As shown in FIG. 12, crack 1202 comprises large residue points 1222, 1224, 1226. Crack 1204 comprises large residue points 1214, 1216, 1218. A line is drawn connecting the large residue points of the cracks so as to form compressed cracks 1202′, 1204′. Notably, compressed cracks 1202′, 1204′ exclusively comprise endpoints and large residue points.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for automatically generating a quality metric for a specified surface area of a terrain, comprising:
acquiring mobile LIDAR data defining a geometry of said specified surface area of said terrain, said mobile LIDAR data being acquired by LIDAR equipment disposed on a vehicle traveling along said terrain; and
automatically determining, by at least one electronic circuit communicatively coupled to said LIDAR equipment, a quality metric defining a quality of said specified surface area of said terrain using said mobile LIDAR data.

2. The method according to claim 1, further comprising performing, by said electronic circuit, a binarization process using said mobile LIDAR data to obtain Black-And-White (“BAW”) LIDAR data comprising black pixels and white pixels, said black pixels defining said cracks.

3. The method according to claim 2, wherein said binarization process comprises determining propagation directions of said cracks, aligning a steerable filter to said propagation directions, and using said steerable filter to convert said mobile LIDAR data to said BAW LIDAR data.

4. The method according to claim 2, further comprising determining, by said electronic circuit, at least one of an average width of cracks defined by said BAW LIDAR data, a total number of pores defined by said BAW LIDAR data, and a total number of spurs defined by said BAW LIDAR data.

5. The method according to claim 2, further comprising filling, by said electronic circuit, at least one pore defined by said BAW LIDAR data.

6. The method according to claim 2, further comprising removing, by said electronic circuit, at least one spur defined by said BAW LIDAR data.

7. The method according to claim 2, further comprising performing, by said electronic circuit, operations to connect cracks having endings that are spaced a certain distance apart from each other.

8. The method according to claim 2, further comprising processing, by said electronic circuit, said BAW LIDAR data to obtain first modified BAW LIDAR data defining cracks with widths of one pixel.

9. The method according to claim 8, further comprising processing, by said electronic circuit, said first modified BAW LIDAR data to reduce a pixel-wide noise thereof so as to obtain second modified BAW LIDAR data with smoothed cracks.

10. The method according to claim 9, further comprising identifying, by said electronic circuit, black pixels of said second modified BAW LIDAR data defining cracks that constitute minutiae and determining, by said electronic circuit, locations of said minutiae.

11. The method according to claim 10, further comprising determining, by said electronic circuit, at least one of a total number of said minutiae, a density of said minutiae, a total number of cracks defined by said second modified BAW LIDAR data, and an average length of said cracks defined by said second modified BAW LIDAR data.

12. The method according to claim 1, wherein said quality metric is determined by comparing a threshold value to a quality measure.

13. The method according to claim 12, wherein the quality measure comprises a total number of cracks defined by data, a total number of pores defined by said data, a total number of spurs defined by said data, a total number of crack connections made, a total number of spurs removed, an average length of said cracks, an average width of said cracks, a total number of minutiae, a density of said minutiae, a depth of said cracks, or a ridge flow disturbance.

14. The method according to claim 1, further comprising determining a maintenance plan for said terrain based on said quality metric and a plurality of other quality metrics.

15. The method according to claim 1, further comprising superimposing said mobile LIDAR data on a map, virtual model or image.

16. A system, comprising:
LIDAR equipment configured to acquire mobile LIDAR data defining a geometry of a specified surface area of a terrain; and
at least one electronic circuit communicatively coupled to said LIDAR equipment and configured to automatically determine a quality metric defining a quality of said specified surface area of said terrain using said mobile LIDAR data.

17. The system according to claim 16, wherein said electronic circuit is further configured to perform a binarization process using said mobile LIDAR data to obtain Black-And-White (“BAW”) LIDAR data comprising black pixels and white pixels, said black pixels defining said cracks.

18. The system according to claim 17, wherein said binarization process comprises determining propagation directions of said cracks, aligning a steerable filter to said propagation directions, and using said steerable filter to convert said mobile LIDAR data to said BAW LIDAR data.

19. The system according to claim 17, wherein said electronic circuit is further configured to determine at least one of an average width of cracks defined by said BAW LIDAR data, a total number of pores defined by said BAW LIDAR data and a total number of spurs defined by said BAW LIDAR data.

20. The system according to claim 17, wherein said electronic circuit is further configured to fill at least one pore defined by said BAW LIDAR data.

21. The system according to claim 17, wherein is said electronic circuit is further configured to remove at least one spur defined by said BAW LIDAR data.

22. The system according to claim 17, wherein said electronic circuit is further configured to perform operations to connect cracks having endings that are spaced a certain distance apart from each other.

23. The system according to claim 17, wherein said electronic circuit is further configured to process said BAW LIDAR data to obtain first modified BAW LIDAR data defining cracks with widths of one pixel.

24. The system according to claim 23, wherein said electronic circuit is further configured to process said first modified BAW LIDAR data to reduce a pixel-wide noise thereof so as to obtain second modified BAW LIDAR data with smoothed cracks.

25. The system according to claim 24, wherein said electronic circuit is further configured to identify black pixels of said second modified BAW LIDAR data defining cracks that constitute minutiae and to determine locations of said minutiae.

26. The system according to claim 25, wherein said electronic circuit is further configured to determine at least one of a total number of said minutiae, a density of said minutiae, a total number of cracks defined by said second modified BAW LIDAR data, and an average length of said cracks defined by said second modified BAW LIDAR data.

27. The system according to claim 16, wherein said quality metric is determined by comparing a threshold value to a quality measure.

28. The system according to claim 27, wherein said quality measure comprises a total number of cracks defined by data, a total number of pores defined by said data, a total number of spurs defined by said data, a total number of crack connections made, a total number of spurs removed, an average length of said cracks, an average width of said cracks, a total number of minutiae, a density of said minutiae, a depth of said cracks, or a ridge flow disturbance.

29. The system according to claim 16, wherein said electronic circuit is further configured to determine a maintenance plan for said terrain based on said quality metric and a plurality of other quality metrics.

30. The system according to claim 16, wherein said electronic circuit is further configured to superimpose said mobile LIDAR data on a map, virtual model or image.
